(19) United States
(12) Patent Application Publication
(10) Pub. No.: US 2006/0132452 A1
(43) Pub. Date: Jun. 22, 2006

(54) Optically addressable matrix display

(75) Inventors: Marcellinus Petrus Carolus Michael Krijn, Eindhoven (NL); Franciscus Paulus Maria Budzelaar, Eindhoven (NL); Jurgen Jean Louis Hoppenbrouwers, Eindhoven (NL); Maurizio Maiani, Eindhoven (NL); Johannes Josephus Wilhelmus Maria Rosink, Eindhoven (NL); Bart Andre Salters, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/545,061

(22) PCT Filed: Jan. 30, 2004
(86) PCT No.: PCT/IB04/50066

§ 371 Date: Aug. 10, 2005

(30) Foreign Application Priority Data
Feb. 13, 2003 (EP) 03100324.7

(51) Int. Cl. G09G 5/00

(52) U.S. Cl. 345/173

(57) ABSTRACT

A matrix display device comprises a matrix of optically addressable pixels (Pij) with a light sensitive element (LSij) which receives data light (Lj) to control a state of the light sensitive element (LSij) depending on the data light (Lj), and a pixel light generating element (LGij) which generates an amount of pixel light (LMij) depending on the state of the light sensitive element (LSij). A select driver (SD) supplies select voltages (SVi) to lines (LRi) of the pixels (Pij), the select voltages (SVi) having a level which does not allow the amount of pixel light (LMij) of the pixel light generating elements (LGij) to be substantially changed for not selected lines (LRi), the select voltages (SVi) having a level which does allow the amount of pixel light (LMij) of the pixel light generating elements (LGij) to be changed for a selected one of the lines (LRi). At least one data light generating device (ALj; LAS) directs the data light (Lj) to the light sensitive element (LSij). A data driver (DD) receives input data (ID) representing an image and controls the at least one data light generating element (ALj; LAS) to produce an amount of light in accordance with the input data (ID).

The invention relates to an active matrix display, and a display apparatus comprising a matrix display.

U.S. Pat. No. 6,215,462 discloses a matrix display device with a plurality of rows of pixels. The rows of the matrix display are selected one by one. Each row is associated with a light waveguide which transports light generated by a select light emission element to the pixels of the row. A particular row is selected if the associated select light emission element produces light; all the other rows are not selected because their associated select light emission elements do not produce light.

Each pixel comprises a series arrangement of a light sensitive element and a pixel light emission element. A data voltage in accordance with the image data to be displayed is supplied to the series arrangement via column conductors. In the selected row of pixels, the light generated by the select light emission element associated with the selected row reaches the pixels of the selected row via the associated light waveguide. Consequently, the light sensitive elements of the pixels of the selected row have a low impedance, and the data voltages occurs substantially over the pixel light emission elements of the pixels of the selected row. Thus, the selected row of pixels will generate an amount of light in accordance with the image data presented on the column conductors which each are connected to a column of pixels. In the rows which are not selected, the select light emission elements do not produce light, and thus the impedance of the light sensitive elements of not selected pixels is high. For these pixels, the data voltage will substantially occur across the high impedance of the light sensitive elements, and consequently, the voltage across the pixel light emission elements will be below a threshold value such that the pixel light emission elements will not produce light.

It is an object of the invention to provide a matrix display with an increased brightness.

A first aspect of the invention provides a matrix display as claimed in claim 1. A second aspect of the invention provides a display apparatus as claimed in claim 14. Advantageous embodiments are defined in the dependent claims.

The matrix display device in accordance with the first aspect of the invention comprises a matrix of optically addressable pixels. The pixels comprise a light sensitive element and a pixel light generating element. For a particular pixel, the light generating element produces a pixel light with a brightness which depends on the state of the associated light sensitive element. The state of the light sensitive element depends on the brightness of light impinging on it. The matrix display further comprises at least one data light generating element which produces the light to be directed to the light sensitive elements in accordance with input data.

The pixels of the matrix display are selected or addressed line by line by supplying appropriate select voltages to the lines of pixels. For not selected lines, the select voltage has a level which does not allow the state of the light generating element to be changed, independent on whether light impinges on the light sensitive element or not. For a selected line, the select voltage has a level which does allow the state of the light generating element to change dependent on whether light impinges on the light sensitive element or not.

In accordance with the image to be displayed, the input data controls the data light generating element to supply data light with a first brightness level to the pixels of the selected line which should produce light, and data light with a second brightness level to the pixels of the selected line which should not produce light.

The operation of such a matrix display is elucidated in the now following. By way of example, only one row of pixels receives a select voltage which allows the pixels of this selected row to be influenced by the data light, the other rows receive a select voltage which prevents the pixels of these non-selected rows to be influenced by the data light. It is possible to select more than one row at a time and to provide the same data to the pixels of these rows. Still, by way of example, the construction of the pixels is such that the pixel light generating element of a particular pixel will produce light if the light sensitive element of this pixel receives the data light with a particular non zero brightness and the pixel light generating element will not produce light if the associated light sensitive element receives the data light with a substantially zero brightness.

Thus only the selected line of pixels is sensitive to the data light generated by the data light generating element and its pixels will generate light if non-zero data light impinges on the pixels. The non-selected lines of pixels are not sensitive to the light generated by the data light generating element and thus keep their optical state unaltered.

In contrast, in the optical addressable display in accordance with the prior art U.S. Pat. No. 6,215,462, the light which impinges on the light sensitive elements of the pixels selects a line of pixels by making the impedance of the light sensitive element low such that the data voltage is substantially present across the light generating element. For a non selected line of pixels, no light impinges on the light sensitive elements which than have a relatively large impedance with respect to the light generating elements. Thus, substantially no voltage occurs across the light generating elements and consequently, not selected lines of pixels can not produce light. This has the drawback that each pixel of a particular row will be addressed during a single row select period only, and thus will only produce light in accordance with the data voltage during this single row select period only. After all the other rows are selected, the pixels of the particular row again will produce light in accordance with the data voltages during a single row select period only.

In the optical addressable matrix display in accordance with the invention, non-selected lines of pixels produce an amount of light determined during the select period of these lines. The brightness of the pixels will be higher because the duration of the period the pixels are producing light is much longer than a single row select period.

In an embodiment in accordance with the invention defined in claim 2, the light generated by the plurality of data light generating elements is transported to a corresponding plurality of lines of pixels via a corresponding plurality of light waveguides. For each line of pixels which is associated with one of the light waveguides, only one data light generating element is used. Preferably, the line of pixels associated with one of the data light generating elements extend in a direction perpendicular to the direction in which the lines of pixels extend to which the same select voltage is supplied. Usually, the conductors supplying the select voltage extend in the row direction and the light waveguides extend in the column direction, but the construction of the matrix display may be transposed.

The addressing of the complete matrix of pixels is elucidated in the now following. For example, for the ease of elucidation, the light waveguides extend in the column direction, and the rows of the matrix display are selected one by one with the select voltage. Again, by way of example only, a row is selected by supplying a high level voltage across its pixels, and the other rows are not selected because a low voltage is supplied to their pixels. The high voltage is selected such that the pixel light generating element of a pixel which receives data light with a non-zero brightness will emit light while a pixel light generating element of a pixel which receives data light with a substantially zero brightness will not emit light The low voltage is selected such that pixels which were addressed earlier to produce light still will produce light while pixels which were addressed earlier to not produce light will not start producing light. Thus, the pixels in the selected row can be switched on or off by the data light transported by the light waveguides, while the state of the pixels in not selected rows is unaltered. The rows and columns may be interchanged.

In an embodiment in accordance with the invention defined in claim 3, the data light generating device comprises a laser for scanning along the light sensitive elements of the pixels. The laser obviates the plurality of light generating elements and light-waveguides otherwise required.

In an embodiment in accordance with the invention defined in claim 4, the data light generating device can be of a simple and cheap construction as the linearity of the light output versus the drive is not important. Gray scales can be produced in such a bi-level display with the known subfield drive.

In an embodiment in accordance with the invention defined in claim 6, in a pixel, an impedance element is arranged in series with the pixel light generating element. The impedance of the impedance element depends on the brightness of the light impinging on the light sensitive element. If the impedance element is the light sensitive element, this has the advantage that a minimal amount of elements is used in a pixel, providing a simple matrix display. It is also possible that the light sensitive element controls another impedance element such as a transistor.

The select voltage is supplied across the series arrangement of the pixel light generating element and the impedance element. If a pixel is in a selected row, the select voltage has a sufficiently high level. If further the impedance of the impedance element is low due to data light impinging on the light sensitive element, the pixel light generating element will generate light because the select voltage is substantially present across it. Alternatively, if further the impedance of the impedance element is high because no data light impinges on the light sensitive element, the pixel light generating element will not generate light because the select voltage is substantially present across the light sensitive element.

In an embodiment in accordance with the invention defined in claim 7, the pixels are constructed such that in a pixel a portion of the pixel light generated by the pixel light generating element reaches the associated light sensitive element of the pixel. The light sensitive element is sensitive to the pixel light to obtain a feedback of the portion of the pixel light to the light sensitive element. This feedback may be used to obtain a memory behavior of the pixel or to influence the memory behavior of the pixel.

With respect to the prior art U.S. Pat. No. 6,215,462, the memory behavior of the pixel will cause the pixel which is switched on during a select period to stay on after the select period. The pixel will generate light during substantially the whole frame period and not only during the select period, and consequently the brightness will increase.

This feedback may also be used to influence an intrinsic memory behavior of a pixel caused by a capacitance of the pixel. The portion of the light impinging on the light sensitive element is used to discharge the capacitance, as is defined in the embodiment of the invention of claim 10.

If a row of pixels is selected by a select voltage which has a sufficient high voltage allowing the state of the pixels to be changed by the data light, the impedance of the light sensitive element will be low with respect to the impedance of the pixel light generating element if data light is received, and the impedance of the light sensitive element will be relatively high if no data light is received. If the impedance of the light sensitive element is low, the select voltage supplied across the series arrangement of the light sensitive element and the pixel light generating element will substantially occur across the pixel light generating element. The pixel light generating element will generate pixel light of which a portion is received by the light sensitive element. As this portion of the light is sufficient to keep the impedance of the light sensitive element low, a memory behavior of the pixel is obtained. Thus, once the pixel light generating element produces light, the state of the light sensitive element will be kept in the state keeping the pixel light generating element in the light emitting state even when no data light is received anymore.

This lowers the constraints put on the levels of the select voltage. The select voltage still has to be large enough during a select period to enable the data light to change the optical state of the selected pixels, and the select voltage has to be low enough for non-selected pixels such that the optical state of the non-selected pixels will not change with the data light. It is not anymore required that the select voltage for non-selected pixels has to be high enough to keep the optical state of these pixels substantially unaltered. The memory behavior of the pixels will take care of this last constraint. However, the level of select voltage should not become so low that the memory behavior of the pixels is lost or that the pixel light generating elements are unable to produce light.

In an embodiment in accordance with the invention defined in claim 8, the light sensitive element itself is arranged in series with the pixel light generating element This has the advantage that the construction of the matrix display is simple.

In an embodiment in accordance with the invention defined in claim 9, a switching element has a main current path arranged in series with the pixel light generating element and a control electrode coupled to the light sensitive element. This has the advantage that the impedance of the light sensitive element is less important. A change of impedance of the light sensitive element caused by the data light or the portion of light generated by the pixel light generating element, will be amplified by the transistor.

In an embodiment in accordance with the invention defined in claim 10, the data light generating device directs the data light towards the further light sensitive element. A short light pulse from the data light generating device suffices to charge the capacitor via the further switching element. The capacitor is discharged by the light sensitive element which receives a portion of the pixel light from the pixel light generating element.

In this manner, the behavior a phosphor of a cathode ray tube is imitated: in response to the data light pulse, the pixel starts with a high brightness which gradually decreases. The value of the capacitor determines the time during which the brightness decreases to zero. The brightness and/or duration of the data light pulse determine the peak brightness of the pixel.

Further, it is an advantage that the brightness of the pixel is substantially independent on the quality of the pixel light generating element if this is a (Poly) LED (light emitting diode). If the (poly) LED does not function well, it will take longer to discharge the capacitor, and thus, the net amount of light produced is substantially equal.

Thus, now the intrinsic memory behavior of the pixels is influenced by the feedback of the portion of the light generated by the pixel light generating element which impinges on the light sensitive element.

In an embodiment in accordance with the invention defined in claim 12, two data light generating elements are associated with a single one of the plurality of data light waveguides. These data light generating elements produce first and second data lights which have different wavelength ranges. The pixels are divided in subgroups, a first color filter is associated with the first subgroup of pixels such that the first data light is able to reach these pixels and to change the state of the pixel light generating element of selected pixels belonging to the first subgroup, while the second data light is blocked. A second color filter is associated with the second subgroup of pixels such that the first data light is blocked and the second data light is able change the state of the pixel light generating element of selected pixels of the second subgroup. It is possible to associate more than two data light generating elements with a single one of the data light waveguides, and to use more than two color filters to separate the pixels in more than two disjunctive groups.

The association of several data light generating elements with a single data light waveguide has the advantage that pixel of the pixel groups can be addressed simultaneously by providing a suitable select voltage to the pixels of the pixel groups which should be addressed (usually the pixel rows). The data light generating elements provide the required data for each of the selected pixels of the different groups in simultaneously.

By way of example, if each of the data light waveguides transports light of two data light generating elements, the first color filters may be associated with pixels of the odd rows, while the second color filters are associated with the pixels of the even rows. One of the data light generating elements produces light which is able to pass the first color filters while it is substantially blocked by the second color filters. The other one of the data light generating elements produces light which is able to pass the second color filters and which is blocked by the first color filters. It is now possible to simultaneously select one of the odd rows and one of the even rows and to provide the required data to the pixels of these selected rows through the same data light waveguide simultaneously because the color filters will only pass the correct data light.

The possibility to simultaneously select pixels of both subgroups of pixels increases the time available for light emission, or the pixels of the matrix display can be addressed more often in a same time period which can be used to create more grey levels as more subfields are possible, or which allows reducing noise artifacts.

In an embodiment in accordance with the invention defined in claim 11, instead of the color filters, light sensitive elements are used which are sensitive to different wavelength ranges of light.

In an embodiment in accordance with the invention defined in claim 13, the two data light generating elements are positioned at opposite ends of the data light waveguides. This has the advantage that the dimensions of the data light waveguides need not be enlarged.

These and other aspects of the invention are apparent from and will be elucidated with reference to the embodiments described hereinafter.

In the drawings:

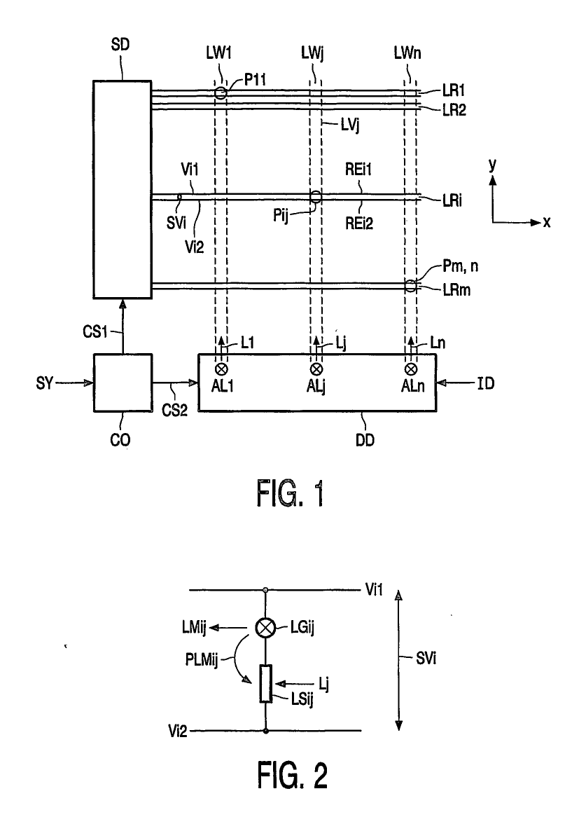

FIG. 1 shows an embodiment of a matrix display apparatus with optically addressed display cells,

FIG. 2 shows an embodiment of a display cell in accordance with the invention,

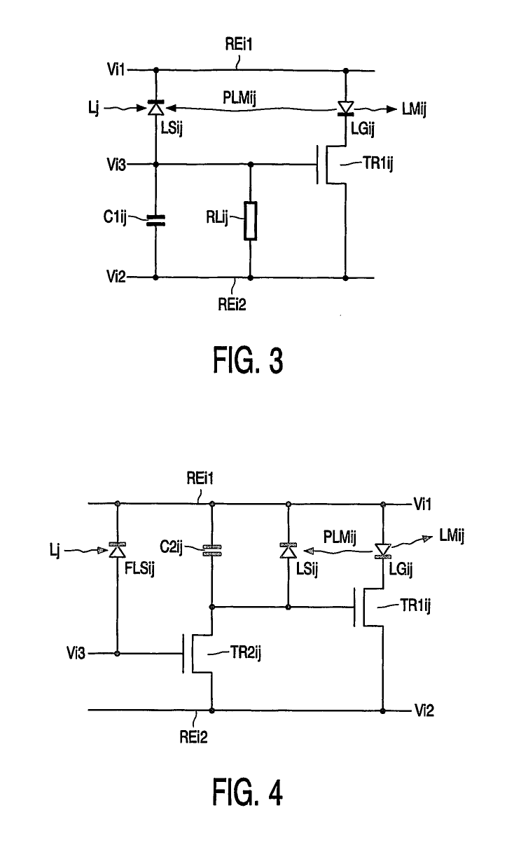

FIG. 3 shows another embodiment of a display cell in accordance with the invention,

FIG. 4 shows another embodiment of a display cell in accordance with the invention,

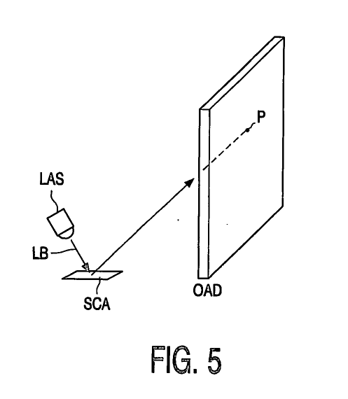

FIG. 5 shows a display apparatus in accordance with the invention wherein the display cells are addressed with a laser,

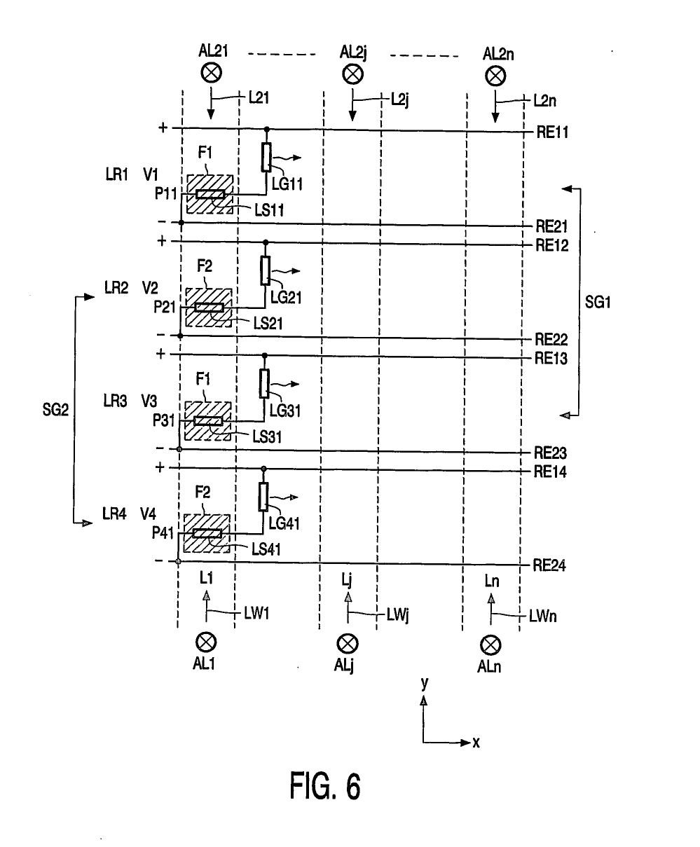

FIG. 6 shows a display apparatus in accordance with the invention wherein more than one data light generating element is associated with the same light waveguide, and

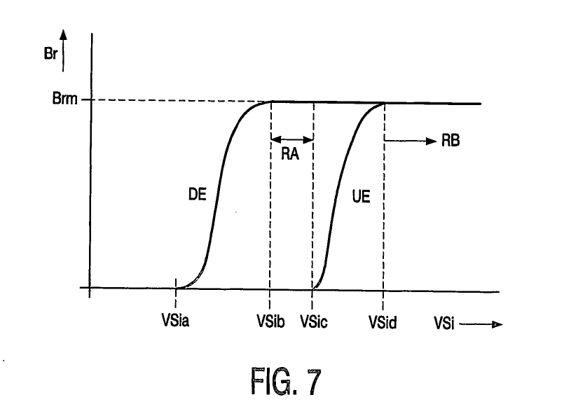

FIG. 7 shows suitable levels of the select voltage.

The same references in different Figs. refer to the same signals or to the same elements performing the same function.

FIG. 1 shows an embodiment of a matrix display apparatus with optically addressed display cells or pixels.

The matrix display comprises a matrix of pixels Pij (P11 to Pmn) which are associated with intersections of light-waveguides LWj (LW1 to LWn) and sets of two row electrodes REi1, REi2. The index i indicates the row number, the index j indicates the column number of the matrix display. The row electrodes REi1 and REi2 extend in the x-direction, the light waveguides LWj extend in the y-direction. In a transposed matrix display, the x and y direction are interchanged.

A select driver SD supplies first row voltages Vi1 to the first row electrodes REi1 and second row voltages Vi2 to the second row electrodes REi2. The select voltage SVi occurs between the first row electrode REi1 and the second row electrode REi2 of the i^{th} row.

A data driver DD receives input data ID to be displayed and data light generating elements ALj which produce data light Lj with a brightness depending on the input data ID and which cooperate with the light waveguides LWj to supply the data light Lj to light sensitive elements LSij, FLSij (see FIGS. 2 to 4) of the pixels Pij.

A control circuit CO receives synchronization information SY to supply a control signal CS1 to the select driver SD to select the rows LRi of pixels Pij one by one, and a control signal CS2 to the data driver DD to supply the data for the selected row LRi.

The pixels Pij of the matrix display are selected or addressed row by row by supplying appropriate select voltages SVi to the rows LRi of pixels Pij. For not selected rows LRi, the select voltage SVi has a level which does not allow the state of the light generating elements LGij to be changed, independent on whether data light Lj impinges on the light sensitive elements LSij or not. The level of the select voltage SVi should however be selected to substantially preserve the state of the light generating elements LGij obtained during a last select period. For a selected row LRi, the select voltage SVi has a level which does allow the state of the light generating elements LGij to change dependent on whether data light Lj impinges on the light sensitive elements LSij or not.

In accordance with the image to be displayed, the input data ID controls the data light generating elements ALj to supply data light Lj to the pixels Pij of the selected row LRi which should produce light, and no data light Lj to the pixels Pij of the selected row LRi which should not produce light, or the other way around depending on the construction of the pixels Pij.

Because the selected row LRi of pixels Pij is sensitive to the data light Lj generated by the data light generating elements ALj, and the non-selected rows LRi of pixels Pij are not sensitive to the data light Lj generated by the data light generating elements ALj, the non-selected lines LRi of pixels Pij preserve their optical state. Consequently, it is possible to change the optical state of the pixels Pij of a selected row LRi in accordance with the input data ID to be displayed while the optical state of these pixels Pij is unaltered during the time the other rows LRi are selected.

The pixels Pij may be formed in a substrate (not shown), the row electrodes REi1 and the row electrodes REi2 may be present at opposite sides of the substrate. One of the row electrodes REi1 or REi2 may be structured as an electrode plate instead of separated electrodes which extend in the row direction.

FIG. 2 shows an embodiment of a display cell in accordance with the invention. In FIG. 2, the display cell or pixel Pij comprise a series arrangement of a pixel light generating element LGij and a light sensitive element LSij of which an impedance depends on an amount of light received. The series arrangement of the pixel light generating element LGij and the light sensitive element LSij is arranged between the first row electrode REi1 and the second row electrode REi2 to receive the select voltage SVi. The voltage on the first row electrode REi1 is denoted by Vi1, the voltage on the second row electrode REi2 is denoted by Vi2, the select voltage SVi is the difference of the voltages Vi1 and Vi2.

For a selected row LRi, the select voltage SVi is sufficiently high and data light Lj impinges on the light sensitive element LSij, the impedance of this light sensitive element LSij will become low with respect to the impedance of the light generating element LGij and thus the select voltage SVi will substantially occur across the light generating element LGij. The pixel Pij will generate light. If no data light Lj impinges on the light sensitive element LSij, its impedance will be high with respect to the impedance of the light generating element LGij, and the select voltage SVi occurs substantially across the light sensitive element LSij. The pixel Pij will not generate light.

For non-selected rows LRi, the select voltage SVi has a suitable low level it does not matter what the brightness of the data light Lj is which impinges on the light sensitive element LSij. Due to the low level of the select voltage SVi, a pixel Pij which was off (not producing light) will not be able to start producing light, and a pixel Pij which was on (producing light) will not be able to stop producing light. The level of the select voltage SVi should however be sufficient high to prevent all pixels Pij to switch off. Suitable levels of the select voltage SVi are elucidated with respect to FIG. 7.

Many constructions of the pixels Pij are possible, for example, it is also possible to use a pixel construction as shown in FIG. 3 wherein the light sensitive element LSij is used to switch a transistor TR1ij of which the main current path is arranged in series with the pixel light generating element LGij. Any other construction of the pixels Pij wherein an impedance value of an element arranged in series with the pixel light generating element LGij depends on whether data light is supplied to the pixel will operate in the same manner.

In an embodiment in accordance with the invention with optical feedback, a portion of the pixel light PLMij produced by the pixel light generating element LGij will reach the light sensitive element LSij.

The operation of the pixel Pij is elucidated in the now following. The total brightness of light falling onto the light sensitive element LSij is the combination of the portion of the pixel light PLMij generated by the pixel light generating element LGij and the data light Lj during the addressing period (or select period) during which the pixel Pij is addressed.

Initially, the pixel Pij is in the off state, even if a considerable select voltage SVi is present across the series arrangement. The high impedance of the light sensitive element LSij causes the select voltage SVi to be substantially present over the light sensitive element LSij, and thus a substantially zero voltage is present across the pixel light generating element LGij.

If a particular pixel Pij should produce light during the addressing period when a row of pixels is addressed, the address light generating element ALj will emit data light Lj which reaches the light sensitive element LSij. The impedance of the light sensitive element LSij will become low with respect to the impedance of the pixel light generating element LGij and the select voltage SVi will be substantially present across the pixel light generating element LGij. The pixel light generating element LGij will start to emit the pixel light LMij. Upon switching off the data light Lj, the pixel Pij remains in the on-state since the portion of the light PLMij generated by the pixel light generating element LGij is captured by the light sensitive element LSij which keeps it impedance low. The pixel Pij is switched off by reducing the select voltage SVi below a threshold value. The pixel Pij thus has an in-built memory brought about by optical feedback to the light sensitive element LSij.

If a particular pixel Pij should not produce light during the addressing period when a row of pixels is addressed, the address light generating element ALj will not emit data light Lj and the impedance of the light sensitive element LSij will stay high.

To drive a complete matrix display with a video signal, all the pixels Pij have to be addressed during a field period to provide a field of input video data ID during this field period to the pixels Pij. The next field of input data ID is supplied to the pixels Pij during the next field period. During a field period, the rows of the matrix display are selected one by one.

Before writing data to the pixels Pij first all pixels Pij have to be reset to produce no light This is possible by reducing the select voltage SVi below a particular threshold value for all the rows. Then, a particular row is selected during a line select period by supplying a select voltage SVi to this row which is sufficiently high. At the same time the address light elements ALj are activated to produce data light Lj for the columns that correspond to the pixel positions within the addressed row that are required to be switched to the on-state wherein the pixel light generating element LGij should emit light. Next, at the end of the line select period, the select voltage SVi is lowered to a value that is sufficient to sustain the pixels Pij within this row, but that is too low to readdress the pixels Pij. Thus the select voltage SVi in not selected rows is too low to alter the state of the pixels Pij but not so low that the pixels Pij are reset

If more grey scales are required it is possible to use the well known sub-field drive method. Each subfield of the field period can be addressed in the same manner as elucidated above for a field period.

The pixel light generating elements LGij and the address light generating elements ALj may, for example, comprise small lasers, LED's (light emitting diodes), OLED's (Organic LED's), PolyLED's, small incandescent lamps or fluorescent lamps, or light generating elements as used in plasma displays. The light sensitive elements may, for example, comprise LDR's (light dependent resistors), or LAS (light activated thyristors or other light activated electronic switches).

Such an optical addressed display is inexpensive and relatively easy to manufacture compared to an LCD. The dimensions are easily scalable, only simple two terminal memory elements are required, and a high lumen efficacy is possible.

FIG. 3 shows another embodiment of a display cell in accordance with the invention. The pixel light generating element LGij is arranged in series with the main current path of a transistor TR1ij between the first row electrode REi1 and the second row electrode REi2. The voltage on the first row electrode REi1 is denoted by Vi1, the voltage on the second row electrode REi2 is denoted by Vi2, the select voltage SVi is the difference of the voltages Vi1 and Vi2. The light sensitive element LSij is arranged between the control electrode of the transistor TR1ij and the first row electrode REi1. An optional capacitor C1ij is arranged between the control electrode of the transistor TR1ij and the second row electrode REi2. An optional leakage resistor RLij is also arranged between the control electrode of the transistor TR1ij and the second row electrode REi2.

If data light Lj impinges on the light sensitive element LSij, the transistor TR1ij becomes low-ohmic and the select voltage VSi is substantially present across the pixel light generating element LGij which starts emitting pixel light LMij. A portion of the pixel light PLMij impinges on the light sensitive element LSij which thus will keep the pixel in the on-state even when the data light Lj is not anymore supplied. The pixel light generating element LGij will stop emitting light when the select voltage SVi drops below a particular value. The pixel light generating element LGij can also be switched off (or on) with the voltage Vi3.

The capacitor C1ij buffers the voltage on the control electrode of the transistor TR1ij and provides a memory behavior. The resistor RLij discharges the capacitor and thus determines the time constant of the memory.

FIG. 4 shows another embodiment of a display cell in accordance with the invention. The pixel light generating element LGij is arranged in series with the main current path of a transistor TR1ij between the row electrode REi1 and the row electrode REi2. The voltage on the row electrode REi1 is denoted by Vi1, the voltage on the row electrode REi2 is denoted by Vi2, the select voltage SVi is the difference of the voltages Vi1 and Vi2. The light sensitive element LSij is arranged between the control electrode of the transistor TR1ij and the row electrode REi1. An optional capacitor C2ij is arranged between the control electrode of the transistor TR1ij and the row electrode REi1. A main current path of a transistor TR2ij is arranged between the control electrode of the transistor TR1ij and the second row electrode REi2. A light sensitive element FLSij is arranged between the control electrode of the transistor TR2ij and the row electrode REi1.

If a short data light pulse Lj impinges on the light sensitive element FLSij, the transistor TR2ij becomes low-ohmic and the capacitor C2ij is charged to the select voltage VSi. The transistor TR1ij starts conducting and the pixel light generating element LGij starts emitting pixel light LMij. The charge on the capacitor C2ij will keep the transistor TR1ij conductive. A portion of the pixel light PLMij impinges on the light sensitive element LSij which will discharge the capacitor C2ij. The impedance of the transistor TR1ij will gradually increase. In this manner, the behavior a phosphor of a cathode ray tube is imitated: in response to the data light pulse Lj, the pixel Pij starts with a high brightness which gradually decreases. The value of the capacitor C2ij determines the time during which the brightness decreases to zero. The brightness and/or duration of the data light pulse Lj determine the peak brightness of the pixel Pij.

Further, it is an advantage that the brightness of the pixel Pij is substantially independent on the quality of the pixel light generating element if this is a (Poly) LED (light emitting diode). If the (poly) LED does not function well, it well take longer to discharge the capacitor C2ij, and thus, the net amount of light produced is substantially equal.

It possible to switch the pixel Pij off with the voltage Vi3 at the control electrode of the transistor TR2ij.

FIG. 5 shows a display apparatus in accordance with the invention wherein the display cells are addressed with a laser. The optical addressable display device OAD comprises the pixels Pij and the row electrodes LRi as shown in FIG. 1. The light-waveguides LWj are not present.

In the embodiment in accordance with the invention as shown in FIG. 1, the optical state of the pixels Pij is controlled by the light generated by the address light elements ALj which light is transported via the light-waveguides LWj to the light sensitive elements LSij of FIG. 2 or the light sensitive elements FLSij of FIG. 4.

In the embodiment in accordance with the invention as shown in FIG. 5, a laser LAS generates the control light Lj which has to impinge on the light sensitive elements LSij of FIG. 2 or the light sensitive elements FLSij of FIG. 4. The scanning of the laser beam LB produced by the laser LAS may be controlled with an x/y scanner SCA. This x/y scanner SCA is mechanically moveable to scan the laser beam LB along the light sensitive elements LSij or FLSij of the display OAD. Preferably, the laser beam LB scans over the rows LRi of the pixels Pij one by one. It is also possible to use more than one laser beam LB.

The laser scanning simplifies the construction of the display because the light-waveguides LWj and the multiple control light generating elements ALj are not required. Further, the data driver DD becomes less complex as a single drive signal for a single laser LAS has to be generated instead of the large amount of drive signals, one for each control light generating element ALj. In a preferred embodiment, the laser LAS is only used to address the pixels Pij and not to generate gray scales. Consequently, a simple diode laser suffices.

The display OAD has a simple construction and thus can be produced easy and cheap. The display OAD may even be a foil. The laser LAS may scan the rear or the front of the display OAD. Rear projection has the advantage that it is easy to prevent the ambient light to reach the light sensitive elements LSij or FLSij. In a front projector, a filter layer in the display OAD has to cover the light sensitive elements LSij or FLSij such that the ambient light is sufficiently blocked and does not influence the state of the pixels Pij, while the laser beam is able to sufficiently pass the filter to be able to control the state of the pixels Pij. It is also possible to use light sensitive elements LSij which are sensitive to the laser light but not to the ambient light.

In a color display, the position of the laser beam LB on the display screen needs to be known to synchronize the intensity of the laser beam LB corresponding to the video information with the position of the Red, Green and Blue pixels of the display OAD.

FIG. 6 shows a display apparatus in accordance with the invention wherein more than one data light generating element is associated with the same light waveguide. By way of example, the matrix display shown comprises four rows LR1 to LR4 and n columns of pixels Pij. The i indicates the row number and in this example runs from 1 to 4 and the j indicates the column number which runs from 1 to n. In FIG. 6 only the four first pixels P11 to P41 in the four rows which form the first column are shown. Each pixel Pij comprises a series arrangement of a pixel light generating element LGij of which LG11 to LG41 are shown, a light sensitive element LSij of which LS11 to LS41 are shown, and color filters F1 and F2. The color filters F1 are associated with the pixels Pij of the odd rows LR1, LR3 and the color filters F2 are associated with the pixels Pij of the even rows LR2, LR4. The pixels Pij of the odd rows LR1, LR3 form a first group SG1 of pixels Pij, the pixels Pij of the even rows LR2, LR4 form a second group SG2 of pixels Pij.

The light waveguides LWj (LW1 to LWn) extend in the column direction. Both a data light generating element ALj and AL2j transport their respective data lights Lj and L2j via the same light waveguide LWj to the same column of pixels Pij.

The operation of the matrix display is elucidated in the now following. The data light generating elements ALj produce data light Lj which is able to pass the first color filters F1 while it is substantially blocked by the second color filters F2. The other data light generating elements AL2j produce data light L2j which is able to pass the second color filters F2 and which is substantially blocked by the first color filters F1. It is now possible to simultaneously select with the select voltages Vi (V1 to V4 is shown) one of the odd rows LR1, LR3 and one of the even rows LR2, LR4 and to provide the required data to the pixels Pij of both these selected rows through the same data light waveguides LWj. The color filters F1 and F2 operate selective on the data lights Lj and L2j in the data light waveguides LWj. The data light Lj will substantially reach the pixels Pij of the odd rows LR1, LR3 only, and the data light L2j will substantially reach the pixels Pij of the even rows LR2, LR4 only.

The possibility to simultaneously select pixels Pij of both subgroups of pixels SG1, SG2 increases the time available for light emission. Or the pixels Pij of the matrix display can be addressed more often in a same time period which can be used to create more grey levels, or which allows reducing noise artifacts as more subfields are possible.

The pixels Pij may be separated in another way in the two groups SG1 and SG2, the position of the color filters F1 and F2 has to be adapted accordingly. Instead of using the color filters F1 and F2 it is also possible to use two groups of different light sensitive elements LSij which are responsive to different wavelength ranges of the impinging light. One group of the light sensitive elements LSij is responsive to the data light Lj and not to the data light L2j, the other group of light sensitive elements LSij is responsive to the data light L2j and not to the data light Lj.

FIG. 7 shows suitable levels of the select voltage. The select voltage VSi is set out along the horizontal axis and the brightness Br of a pixel Pij is set out along the vertical axis. If the pixel Pij is off at a low value of the select voltage VSi (VSi<VSia) and thus the brightness Br is very low or zero, and the select voltage VSi is increased, the pixel Pij will start emit light according to the curve UE. Thus above the value VSic, the pixel Pij starts emitting light and the maximum brightness Brm is available for select voltages above the value VSid. When successively, the select voltage VSi is decreased the brightness of the pixel will follow the curve DE. Thus the brightness starts decreasing at the level VSib and is low below the level VSia Due to the hysteretic behavior of the pixel Pij, three areas are available. The pixel brightness Br is low below the level VSia, thus the pixels Pij can be switched off by lowering the select voltage VSi below the level VSia. Within the area RA, pixels Pij which where on (have the high brightness level Brm) will stay on and pixels which are off (have the low brightness level) will stay off. Within the area RB, the select voltage SVi is sufficiently large to switch a pixel Pij on when light impinges on the pixel Pij.

In a practical embodiment the levels are approximately: VSib=4 Volts, VSic=5 Volts, and VSid=7 Volts. These levels are indications only and may differ for different displays and different configurations of the pixels Pij.

It should be noted that the above-mentioned embodiments illustrate rather than limit the invention, and that those skilled in the art will be able to design many alternative embodiments without departing from the scope of the appended claims.

For example, the transistors which are shown to be MOSFETS, may also be bipolar transistors. All the transistors may be of the opposite conductivity type, the circuits have to be adapted in a manner known to the skilled person.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A matrix display device with a matrix of optically addressable pixels (Pij) comprising:
a light sensitive element (LSij) having a state being controllable by data light (Lj), and
a pixel light generating element (LGij) for generating pixel light (LMij) having a brightness depending on the state of the light sensitive element (LSij),
the matrix display device comprising:
a data light generating device (ALj; LAS) for generating the data light (Lj),
a data driver (DD) for receiving input data (ID) representing an image and for controlling the data light generating device (ALj; LAS) to produce a brightness of the data light (Lj) in accordance with the input data (ID), and
a select driver (SD) for supplying select voltages (SVi) to lines (LRi) of the pixels (Pij), the select voltages (SVi) having a level for preventing a substantial change of the brightness of the pixel light (LMij) of the pixels (Pij) of not selected ones of the lines (LRi), and the select voltages (SVi) having a level allowing a change of the brightness of the pixel light (LMij) of the pixels (Pij) of a selected one of the lines (LRi).

2. A matrix display device as claimed in claim 1, wherein the lines (LRi) of the pixels (Pij) extend in a first direction (x), and wherein the data light generating device (ALj; LAS) comprises a plurality of data light generating elements (ALj) and a same plurality of associated light waveguides (LWj) for transporting a plurality of data lights (Lj) to an associated plurality of lines (LVj) of the pixels (Pij) extending in a second direction (y) substantially perpendicular to the first direction (x), and wherein the data driver (DD) is arranged for controlling the plurality of data light generating elements (ALj) to produce a brightness of the data lights (Lj) in accordance with the input data (ID).

3. A matrix display device as claimed in claim 1, wherein the data light generating device (ALj; LAS) comprises a laser (LAS) for generating a laser beam (LB), and scanning means (SCA) for scanning the laser beam (LB) along the light sensitive elements (LSij) of said pixels (Pij), the data driver (DD) being arranged for controlling the laser (LAS) to produce a brightness in accordance with the input data (ID).

4. A matrix display device as claimed in claim 2, wherein the data driver (DD) is arranged for controlling the data light generating device (ALj; LAS) to produce two brightness levels only.

5. A matrix display device as claimed in claim 1, wherein the light sensitive element (LSij) is a light-dependent resistor or a light-activated switch.

6. A matrix display as claimed in claim 1, wherein the pixel light generating element (LGij) and an impedance element (LSij; TR1ij) are arranged in series, said series arrangement being coupled to the select driver (SD) for receiving an associated one of the select voltages (SVi), an impedance of the impedance element (LSij; TR1ij) being dependent on a state of the light sensitive element (LSij).

7. A matrix display device as claimed in claim 1, wherein the light sensitive element (LSij) and the pixel light generating element (LGij) are positioned with respect to each other for obtaining an optical feedback of a portion (PLMij) of the pixel light (LMij) generated by the pixel light generating element (LGij) to the light sensitive element (LSij).

8. A matrix display device as claimed in claim 7, wherein the light sensitive element (LSij) and the pixel light generating element (LGij) of the pixel (Pij) are arranged in series, and wherein the portion of the pixel light (PLMij) reaching the light sensitive element (LSij) is sufficient for keeping an impedance of the light sensitive element (LSij) relatively low with respect to an impedance of the pixel light generating element (LGij).

9. A matrix display device as claimed in claim 7, wherein the pixels (Pij) further comprise a switching element (TR1ij ) having a control electrode coupled to the light sensitive element (LSij) and a main current path arranged in series with the pixel light generating element (LGij), said series arrangement being coupled to the select driver (SD) for receiving an associated one of the select voltages (SVi), and wherein the portion of the pixel light (PLMij) reaching the light sensitive element (LSij) is sufficient for obtaining an impedance of the main current path of the switching element (TR1ij) being relatively low with respect to an impedance of the pixel light generating element (LGij).

10. A matrix display device as claimed in claim 9, wherein the pixels (Pij) further comprise:
a capacitor (C2ij) coupled to the control electrode of the first mentioned switching element (TR1ij),
a further light sensitive element (FLSij) for receiving the data light (Lj), and
a further switching element (TR2ij) having a control electrode coupled to the further light sensitive element (FLSij) and a main current path coupled to the control electrode of the first mentioned switching element (TR1ij).

11. A matrix display device as claimed in claim 2, wherein the matrix display device comprises
a further plurality of data light generating elements (AL2j) for generating a further plurality of data lights (L2j), wherein with each of the plurality of light waveguides (LWj) is associated both one of the first mentioned plurality of data light generating elements (ALj) and one of the further plurality of data light generating elements (AL2j), and wherein a first wavelength range of the first mentioned plurality of data lights (Lj) and a second wavelength range of the further plurality of data lights (L2j) differ,
a first group of the light sensitive elements (LSij) associated with the pixels (Pij) of a first sub-group (SG1) of the lines (LRi) of pixels (Pij) extending in the first direction (x) being responsive to light within the first wavelength range and substantially not to light within the second wavelength range, and
a second group of the light sensitive elements (LSij) associated with the pixels (Pij) of a second sub-group (SG2) of the lines (LRi) of pixels (Pij) extending in the first direction (x) being responsive to light within the second wavelength range and substantially not to light within the first wavelength range, the first subgroup (SG1) and the second subgroup (SG2) being disjunct.

12. A matrix display device as claimed in claim 2, wherein the matrix display device comprises
a further plurality of data light generating elements (AL2j) for generating a further plurality of data lights (L2j), wherein with each of the plurality of light waveguides (LWj) is associated both one of the first mentioned plurality of data light generating elements (ALj) and one of the further plurality of data light generating elements (AL2j), and wherein a first wavelength range of the first mentioned plurality of data lights (Lj) and a second wavelength range of the further plurality of data lights (L2j) differ,
first color filters (F1) being associated with the pixels (Pij) of a first sub-group (SG1) of the lines (LRi) of pixels (Pij) extending in the first direction (x) for transferring light within the first wavelength range and substantially blocking light within the second wavelength range, and
second color filters (F2) being associated with the pixels (Pij) of a second sub-group (SG2) of the lines (LRi) of pixels (Pij) extending in the first direction (x) for transferring light within the second wavelength range and substantially blocking light within the first wavelength range, the first subgroup (SG1) and the second subgroup (SG2) being disjunct.

13. A matrix display device as claimed in claim 11, wherein the first mentioned and the further plurality of data light generating elements (ALj, AL2j) are positioned at opposite sides of the of the light waveguides (LWj).

14. A display apparatus comprising a matrix display as claimed in claim 2.

15. A display apparatus as claimed in claim 13, wherein one of the select voltages (SVi) associated with a selected one of the lines (LRi) extending in a first direction (x) is selected sufficiently high to enable the pixel light generating element (LGij) to produce light (LMij; FLMij) when the light (Lj) of the further light generating element (ALj) reaches the associated light sensitive element (LSij), and to produce no light when no light is received from the further light generating element (ALj), while select voltages (SVi) associated with non-selected lines (LRi) have levels both not high enough and not too low to alter a state of the associated pixel light generating element (LGij).
